(19) United States
(12) Patent Application Publication
(10) Pub. No.: US 2014/0376994 A1
(43) Pub. Date: Dec. 25, 2014

(54) Fastening device and fastening arrangement for fastening an interior equipment element of a vehicle

(71) Applicant: SIEMENS AKTIENGESELLSCHAFT, MUENCHEN (DE)

(72) Inventor: Mihail Calomfirescu, Essen (DE)

(73) Assignee: Siemens Aktiengesellschaft, Munchen (DE)

(21) Appl. No.: 14/375,878

(22) PCT Filed: Dec. 12, 2012
(86) PCT No.: PCT/EP2012/075177

§ 371 Date: Jul. 31, 2014

(30) Foreign Application Priority Data
Jan. 31, 2012 (DE) 102012201291.5

(51) Int. Cl. B60N 2/015; B60N 2/54; B60N 2/50; B60N 2/07

(52) U.S. Cl. CPC B60N 2/015; B60N 2/0722; B60N 2/542; B60N 2/509
USPC 403/220

(57) ABSTRACT

A fastening device fastening an interior equipment element, particularly a passenger seat, to a side wall of a vehicle, preferably a rail vehicle, includes a fastening element forming a C-profile rail receiving slot nuts detachably fastening the interior equipment element to the fastening device on the wall side. The fastening device can be or is fastened to a structure of the side wall and has an elastic damping configuration elastically fastening the fastening device to the structure of the side wall embodied as a wall structure by an adhesive bond and a damping element elastically supporting the fastening device on a further structure of the side wall embodied as a protrusion. A fastening configuration fastening an interior equipment element to a side wall of a vehicle, preferably a rail vehicle, includes a structure of the side wall and a corresponding fastening device permanently or detachably fastened to the structure.

The invention relates to a fastening device for fastening an interior equipment element, particularly a passenger seat, to a side wall of a vehicle, preferably a rail vehicle, having at least one fastening element which forms a C-profile rail for receiving slot nuts for fastening the interior equipment element to the fastening device in a detachable manner on the wall side, wherein the fastening device, for its part, can be fastened or is fastened to at least one structure of the side wall.

The invention furthermore relates to a fastening arrangement for fastening an interior equipment element, particularly a passenger seat, to a side wall of a vehicle, preferably a rail vehicle, having at least one structure of the side wall and a fastening device which is permanently or detachably fastened to said structure.

A device of this type and an arrangement of this type are known, for example, from DE 10 2008 039 165 A1, in which a fastening device for fastening an interior equipment element, particularly a passenger seat, to a side wall of a vehicle is described. This device has at least one fastening element which forms a C-profile rail for receiving slot nuts for fastening the interior equipment element to the fastening device in a detachable manner on the wall side. The fastening device here, for its part, is fastened integrally to at least one structure of the side wall.

It is the object of the present invention to specify a fastening device and a fastening arrangement which ensure a simple fastening and safe use of the interior equipment element in the passenger compartment of the vehicle.

The object is achieved by the features of independent claims 1 and 10. Advantageous refinements are specified in the dependent claims.

In the case of the fastening device according to the invention, provision is made for said fastening device to have at least one elastic damping device for elastically fastening the fastening device to the at least one structure of the side wall, which structure is designed as a wall structure, by means of an adhesive bond, and to have at least one elastic damping element for elastically supporting the fastening device on at least one further structure of the side wall, which structure is designed as a protrusion.

In the simplest case, the outwardly facing side of the elastic damping element is provided with an adhesive layer which forms the adhesive bond with the wall structure when the fastening device is mounted.

A fastening of an interior equipment element, particularly a passenger seat, to a side wall of a vehicle via a fastening device of this type having at least one elastic damping device and at least one elastic damping element has the advantage that a mechanical and also thermal decoupling between interior equipment element and side wall is ensured. This means an increase in comfort for the users of interior equipment elements, such as a passenger seat. At the same time, elastic parts of this type compensate for tolerances during the mounting, thus making the installation and the fastening of the interior equipment element to a side wall easier.

Furthermore, such a fastening device ensures that the elastic damping device and the elastic damping element absorb a certain amount of energy during an impact, which increases the safety of the vehicle occupants.

The fastening element is advantageously composed of light metal or a light metal alloy. In particular, provision is made here for the fastening element to be composed of aluminum or an aluminum alloy. The light metal aluminum is a preferred material for a fastening element forming a C-profile rail.

According to a preferred embodiment of the invention, the fastening element is designed as an extruded profile.

According to a further preferred embodiment of the invention, provision is made for the fastening element to have wing-like extension arms, on which the elastic damping devices are arranged, on both sides of the C-profile rail. The fastening of the elastic damping devices to said extension arms ensures a high degree of stability.

According to yet another preferred embodiment of the invention, provision is made for the at least one damping device to have a damping layer made of a foam material. The damping layer made of a foam material ensures good thermal and mechanical decoupling of side wall and interior equipment element.

According to a preferred refinement of the invention, the damping device has a sheet-metal element which is arranged on the upper side of the damping device, which upper side is opposite the interface between the damping layer and the fastening element. A sheet-metal element of this type ensures that pressure is distributed uniformly to the elastic damping layer located there below. At the same time, the sheet-metal element protects the damping layer against external influences. This is advantageous in particular for a damping layer made of a foam material. Said damping layers are often highly sensitive.

Provision is advantageously made for the sheet-metal element to be provided on the upper side thereof with an elastic adhesive layer which forms the adhesive bond and is intended for fastening to the wall structure of the side wall. Said adhesive layer contributes to the elasticity and to the decoupling resulting therefrom.

According to another preferred refinement of the invention, the damping device, or at least one of the plurality of damping devices, in one of the side regions thereof with the fastening element, forms a continuously flat head end, on which the elastic damping element is arranged.

Finally, provision is advantageously made for the damping element to be a damping element made of rubber.

In the case of the fastening arrangement according to the invention, provision is made for the at least one structure to be designed as a wall structure, wherein the fastening arrangement comprises at least one further structure of the side wall, which structure is designed as a protrusion. The fastening device is designed as an abovementioned fastening device fastened elastically via the at least one elastic damping device thereof to the wall structure and is supported via the at least one elastic damping element thereof on the protrusion. The two structures of the side wall particularly together form an inner edge. The interior equipment element is supported on said inner edge via the fastening device or is fastened to said inner edge.

Exemplary embodiments of the invention are explained in more detail below with reference to drawings, in which

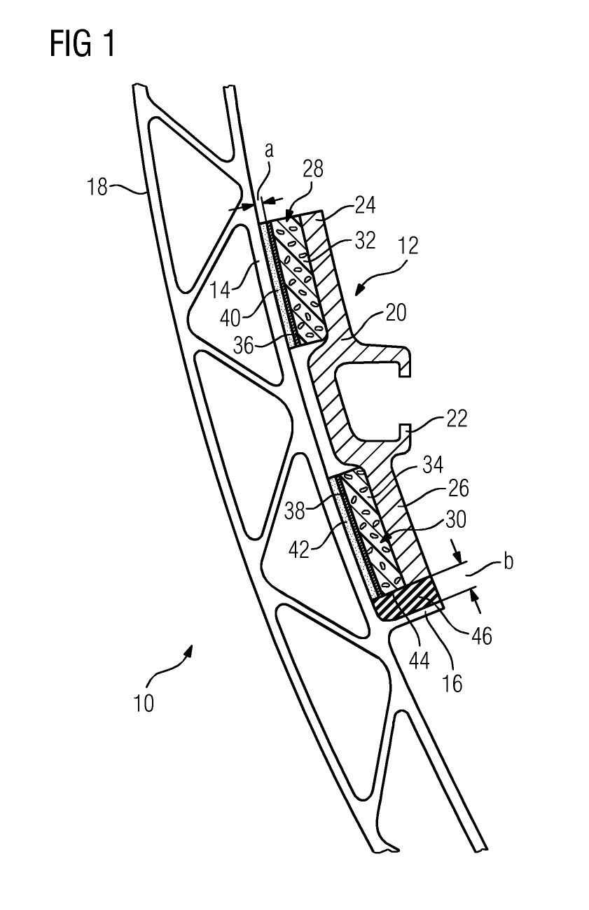

FIG. 1 shows a fastening arrangement according to a first preferred embodiment of the invention, and

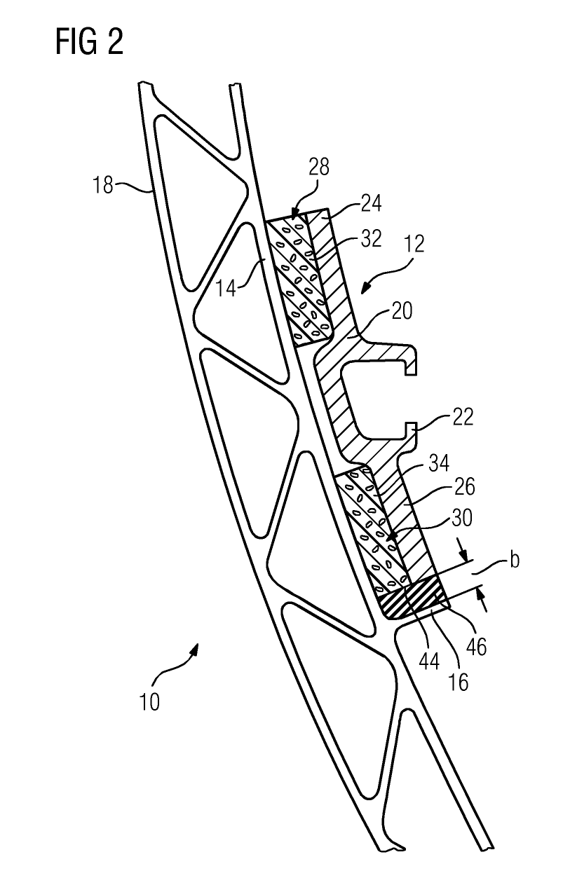

FIG. 2 shows a fastening arrangement according to a second preferred embodiment of the invention.

FIG. 1 shows a fastening arrangement 10 with a fastening device 12 and two structures 14, 16 of a side wall 18 of a vehicle in the form of a rail vehicle. The first of the two structures 14 is a wall structure formed in a region by the inside of the side wall 18 and the second of the two structures 16 is a protrusion extending into the interior of the vehicle. The two structures 14, 16 form an inner edge on the side wall 18.

The fastening device 12 is a fastening device for fastening an interior equipment element (not shown) to the side wall 18. The interior equipment element is particularly a passenger seat or a row of passenger seats. The fastening device 12 has a fastening element 20 which forms a C-profile rail 22 for receiving slot nuts for fastening the wall-supported element in a detachable manner on the wall side. A fastening of this type of an interior equipment element by means of a slot nut is known, for example, from DE 10 2008 039 165 A1, which is mentioned at the beginning.

The fastening element 20 is designed as an integral extruded profile made of aluminum (aluminum extruded profile) which has the C-profile rail 22 and two wing-like extension arms 24, 26 on both sides of the C-profile rail 22, which extension arms are in each case connected integrally to the C-profile rail 22. The extension arms 24, 26 extend over the entire length thereof in the longitudinal direction of the C-profile rail 22 or of the fastening element 20. The longitudinal direction is oriented horizontally on the side wall 18. The fastening element 20 which is fastened to the side wall 18 is oriented here in such a manner that a first of the extension arms 24 is arranged above the C-profile rail 22 and a second of the extension arms 24 is arranged below the C-profile rail 22.

An elastic damping device 28, 30 of the fastening device 12 is fastened to each of the extension arms 24, 26 on the side thereof assigned to the side wall. Each of the damping devices has an elastic damping layer 32, 34 which adjoins the fastening element 20, or more precisely, the extension arms 24, 26 of the fastening element 20 and is made of a foam material. Furthermore, each of the damping devices 28, 30 has a sheet-metal element 36, 38 which is arranged on the upper side of the damping device 28, 30, which upper side is opposite the interface between the respective damping layer 32, 34 and the fastening element 20. The respective sheet-metal element 36, 38 is provided on the upper side thereof with an elastic adhesive layer 40, 42 which forms the adhesive bond and by means of which the fastening device is fastened to the wall structure 14 of the side wall 18. Said adhesive layer has a continuous, finite thickness a.

The lower of the two damping devices 30, in one of the side regions thereof with the fastening element 20, or more precisely with the corresponding extension arm 26 of the fastening element 20, forms a continuously flat head end 44, on which an elastic damping element 46 of the fastening device 12 is arranged. This damping element 46 has a continuous, finite strength b and is a damping element made of rubber. The fastening device 12 is supported on the protrusion 16 via said damping element 46.

Tolerances can be compensated for by varying the thickness a of the adhesive layers 40, 42 and the strength b of the damping element.

FIG. 2 shows a fastening arrangement 10 which substantially corresponds to the fastening arrangement 10 of FIG. 1, and therefore only the differences will be discussed here. The differences reside in the configuration of the damping devices 28, 30 and of the adhesive bonds.

The damping devices 28, 30 shown in FIG. 2 respectively have a damping layer 32, 34 and adhesive applied thereon for forming the adhesive bond. The adhesive bond formed in this manner is a purely structural bond without additional requirements regarding the elasticity thereof and the possibilities of compensating for tolerances.

The first alternative, which is illustrated in FIG. 1, and the advantages thereof will be described once again below using different words:

The fastening device 12 has a fastening element 20 which is designed as an aluminum extruded profile and contains the C-profile rail, on which an elastic foam forming damping layers 32, 34 is adhesively bonded. The thin sheet-metal element 36, 38 is in each case also adhesively bonded on said foam using a structural adhesive, in order to distribute the contact pressure in a sheet-like manner during the adhesive bonding. The entire construction is once again also adhesively bonded to a respective adhesive layer 40, 42 made of elastic adhesive. The mounted fastening device 12 is then fastened to the side wall 18 by means of said adhesive layers 40, 42.

Furthermore, in order to absorb vertical loads, the damping element 46 of the strength b and made of rubber, in particular hard rubber, is located in the lower region of the fastening device 12. By adaptation of the strength b of the damping element 46 made of rubber and the thickness a of the elastic adhesive, it is possible to compensate for tolerances.

The fastening of the interior equipment element to the side wall 18 by means of the fastening device 12 is characterized by:
thermal and mechanical decoupling of the interior equipment element from the side wall 18 and optionally also from the floor of the vehicle by means of the damping layer made of elastic foam,
the possibility of compensating for tolerances by adapting the thickness a of the adhesive and the strength b of the damping element made of rubber,
the possibility of elastically plastic deformation and, as a result, of absorption of energy of the fastening device 12 in the event of a crash, given a sufficient flexural rigidity of the C-profile rail, and
improved thermal insulation by avoiding the thermal bridges between side wall 18 and interior equipment element.

1-10. (canceled)

11. A fastening device for fastening an interior equipment element to a side wall of a vehicle, the fastening device comprising:
at least one fastening element fastened or configured to be fastened to at least one wall structure of the side wall, said at least one fastening element forming a C-shaped rail configured to receive slot nuts for detachably fastening the interior equipment element to the fastening device at the side wall;
at least one elastic damping device configured to elastically fasten the fastening device to the at least one wall structure of the side wall by an adhesive bond; and
at least one elastic damping element configured to elastically support the fastening device on at least one further structure of the side wall constructed as a protrusion.

12. The fastening device according to claim 11, wherein the interior equipment element is a passenger seat and the vehicle is a rail vehicle.

13. The fastening device according to claim 11, wherein said at least one fastening element is composed of light metal or a light metal alloy.

14. The fastening device according to claim 11, wherein said at least one fastening device is constructed as an extruded profile.

15. The fastening device according to claim 11, wherein:
said at least one elastic damping device includes two elastic damping devices;
said C-shaped rail has two sides;
said at least one fastening element has wing-shaped extension arms; and
said elastic damping devices are each disposed on a respective one of said wing-shaped extension arms on a respective one of said sides of said C-shaped rail.

16. The fastening device according to claim 11, wherein said at least one damping device has a damping layer formed of a foam material.

17. The fastening device according to claim 16, wherein:
said at least one damping device has an upper side disposed opposite an interface between said damping layer and said at least one fastening element; and
said at least one damping device has a sheet-metal element disposed on said upper side of said at least one damping device.

18. The fastening device according to claim 17, wherein:
said sheet-metal element has an upper side; and
an elastic adhesive layer is disposed on said upper side of said sheet-metal element and forms said adhesive bond configured to fasten the fastening device to the at least one wall structure of the side wall.

19. The fastening device according to claim 11, wherein said at least one damping device is one damping device having a side region forming a continuously flat head end along with said at least one fastening element, and said at least one elastic damping element is disposed on said continuously flat head end

20. The fastening device according to claim 11, wherein said at least one damping device includes a plurality of damping devices, one of said plurality of damping devices has a side region forming a continuously flat head end along with said at least one fastening element, and said at least one elastic damping element is disposed on said continuously flat head end.

21. The fastening device according to claim 11, wherein said at least one damping element is formed of rubber.

22. A fastening configuration, comprising:
a vehicle side wall configured to have an interior equipment element fastened thereto, said vehicle side wall having at least one wall structure and at least one further structure constructed as a protrusion; and
a fastening device according to claim 1;
said fastening device being permanently or detachably elastically fastened to said at least one wall structure by said at least one elastic damping device, and
said fastening device being supported on said protrusion by said at least one elastic damping element.

23. The fastening configuration according to claim 22, wherein the interior equipment element is a passenger seat and the vehicle is a rail vehicle.
